(19) United States
(12) Patent Application Publication
(10) Pub. No.: US 2005/0074558 A1
(43) Pub. Date: Apr. 7, 2005

(54) Process solution supply system and method

(75) Inventors: Hong-Je Cho, Suwon-city (KR); Jin-Su Kim, Asan-city (KR); Sung-Chul Kang, Yongin-city (KR)

Correspondence Address: MacPherson Kwok Chen & Heid LLP, Suite 226, 1762 Technology Drive, San Jose, CA, 95110, US

(73) Assignee: SAMSUNG ELECTRONICS CO., LTD., Suwon-city (KR)

(21) Appl. No.: 10/863,113

(22) Filed: Jun. 7, 2004

(30) Foreign Application Priority Data
Sep. 18, 2003 (KR) 2003-0064817

(51) Int. Cl. B05C 5/00

(52) U.S. Cl. 427/421.1; 118/313; 118/300

(57) ABSTRACT

A process solution supply system and method for advantageously supplying process solution are provided. A process solution supply device provides process solution at a controlled temperature to a processing unit for injection of the process solution onto substrates through a plurality of nozzles. The process solution is transported to the nozzles through a pathway, which in one example can include a piping arrangement. The pathway advantageously uses temperature control through contact piping, a thermo-sensor, and piping arrangement, such that the process solution injected through the plurality of nozzles is substantially equal to the temperature of the process solution originally supplied from the process solution supply device.

### BACKGROUND

(a) Field of the Invention

The present invention relates to a process solution supply system and method, and particularly to a process solution supply system and method used in manufacturing a liquid crystal display.

(b) Description of Related Art

A liquid crystal display (LCD) is one of the most popular flat panel displays, which includes two panels provided with two kinds of electrodes generating an electric field and a liquid crystal layer interposed therebetween. The LCD displays images by controlling light transmittance, and the control of the light transmittance is performed by applying voltages to the electrodes to generate electric fields which change the arrangement of liquid crystal molecules.

In a manufacturing process of an LCD, a plurality of conductive and insulating layers are developed, etched, and/or cleaned using various process solutions.

As the size of the panel becomes larger and patterns become more integrated to increase productivity, the margin of etching uniformity decreases, which may cause poor uniformity and stains. With all other conditions being the same, as the temperature of the process solution increases, the etch rate increases, and conversely, as the temperature of the process solution decreases, the etch rate decreases. Therefore, for a large size panel, the etch rate varies between the center and edge portions of the panel due to the temperature difference between the center and edge portions.

Thus, it is preferable that the temperature of the process solution injected onto the panel be maintained to be constant to prevent poor uniformity of etching. In order to maintain the temperature of the process solution, a process solution circulation device, which is a process solution supply device, is controlled. However, it is difficult to control the temperature of the process solution accurately because the LCD panel is placed in a process device which is distant from the process solution circulation device, which makes it difficult to keep a constant process solution temperature and accordingly various portions of the panel are not etched at the same rate. Thus, there is a need in the art for a process solution supply system and method to etch substrates consistently and efficiently.

### SUMMARY

The present invention provides an advantageous process solution supply system and method to allow for constant etch rates across a substrate.

According to one embodiment of the present invention, a process solution supply system is provided, including a process solution supply device for supplying a process solution at a first temperature, wherein the process solution supply device includes a first temperature control, and a processing unit including a plurality of nozzles for injecting the process solution onto a substrate. The system further includes a pathway operably coupling the process solution supply device to the plurality of nozzles, wherein the pathway includes multiple paths and a second temperature control such that the process solution injected from the plurality of nozzles has a temperature substantially equal to the first temperature of the process solution from the process solution supply device.

According to another embodiment of the present invention, a process solution supply system is provided, including the aforementioned elements and a pathway operably coupling the process solution supply device to the plurality of nozzles, wherein the pathway includes a second temperature control and a main supply pipe arranged in parallel to a plurality of nozzle pipes, the main supply pipe being operably coupled to the plurality of nozzle pipes via a plurality of connecting pipes arranged perpendicular to the plurality of nozzle pipes, such that the process solution injected from the plurality of nozzles has a temperature substantially equal to the first temperature of the process solution from the process solution supply device.

According to yet another embodiment of the present invention, a method for supplying process solution is provided, including providing a process solution source that controls for temperature to supply process solution at a first temperature, and providing a plurality of nozzles for injecting the process solution from the process solution source onto a substrate. The method further includes transporting the process solution from the process solution source to the plurality of nozzles via a pathway that controls for temperature such that the process solution injected from the plurality of nozzles has a temperature substantially equal to the first temperature of the process solution from the process solution supply source.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 is a schematic diagram of a process solution supply system according to an embodiment of the present invention;

FIG. 2 is a layout view of a process solution supply system according to an embodiment of the present invention which includes two assistant connection pipes; and

FIG. 3 is a layout view of a process solution supply system according to an embodiment of the present invention which includes three assistant connection pipes.

Use of the same reference symbols in different figures indicates similar or identical items. It is further noted that the drawings may not be drawn to scale.

### DETAILED DESCRIPTION

The present invention is directed toward a process solution supply system and method which is able to control the temperature of the process solution injected onto a large size panel, advantageously allowing for consistent and efficient etching.

The present invention will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, region or substrate is referred to as being “on” another element, the element can be directly on the other element or intervening elements may also be present. In contrast, when an element is referred to as being “directly on” another element, there are no intervening elements present.

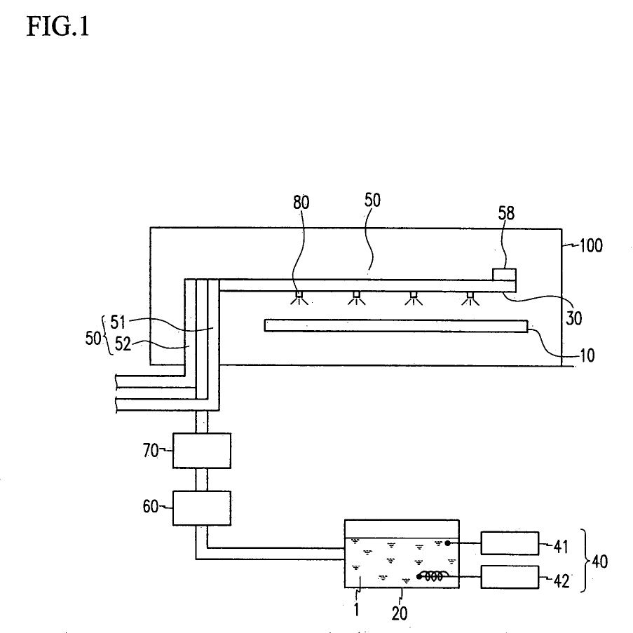

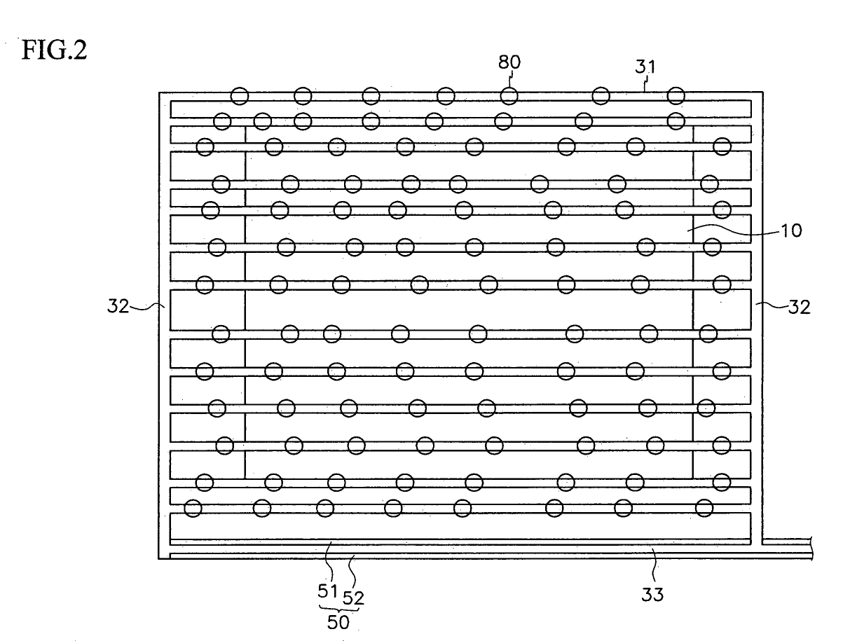

Now, a process solution supply system and method according to an embodiment of the present invention will be described in detail with reference to FIGS. 1 and 2.

Referring to FIGS. 1 and 2, a process solution supply system according to an embodiment of the present invention includes a process solution supply device 20 supplying a process solution 1, for example an etching solution, and a process solution supply pipe 30 which is a pathway through which the process solution supplied from process solution supply device 20 flows. A plurality of nozzles 80 are arranged on an end portion of process solution supply pipe 30 inside a manufacturing device 100, and a process solution is injected via the plurality of nozzles 80 onto a substrate 10 placed under the plurality of nozzles 80. Thus, process solution 1 inside process solution supply device 20 is injected onto substrate 10 inside manufacturing device 100 via process solution supply pipe 30.

It is preferable that process solution supply device 20 be connected to a recirculation line (not shown) from manufacturing device 100 to supply device 20 to allow for reuse of remaining injected process solution. A first temperature controller 40 is operably connected to process solution supply device 20 to control the temperature of process solution 1 inside process solution supply device 20. First temperature controller 40 includes a thermometer 41 for measuring the temperature of process solution 1 inside process solution supply device 20 and a heater 42 for controlling the temperature of process solution 1 inside process solution supply device 20. The temperature of process solution 1 inside process solution supply device 20 is measured by thermometer 41 and controlled by heater 42 to be at a designated temperature using proportional integral derivative (PID) control techniques.

As shown in FIG. 2, a portion of process solution supply pipe 30 is placed inside manufacturing device 100 (FIG. 1) and includes a plurality of nozzle bars 31 having a plurality of nozzles 80 and two assistant connection bars 32 for connecting the plurality of nozzle bars 31 and process solution supply device 20 (FIG. 1).

The plurality of nozzle bars 31 are set apart from the substrate to be etched by a prescribed distance. Each nozzle bar swings between about 35 and about 45 degrees to the left and right and injects the process solution onto substrate 10 through the plurality of nozzles 80.

The two assistant connection bars 32 are arranged at both end points of nozzle bars 31 for connecting the plurality of nozzle bars to each other. A main connection bar 33 is arranged parallel to nozzle bars 31 and operably connected to the two assistant connection bars 32. The process solution supplied from process solution supply device 20 through main connection bar 33 is supplied to the plurality of nozzle bars 31 through assistant connection bars 32. The process solution can flow from one connection bar 32 to the other or alternatively through both connection bars 32 simultaneously.

Calorie consumption or heat loss of the process solution is decreased by utilizing the two assistant connection bars 32 in which the process solution flows. That is, calorie consumption of the process solution can be minimized by decreasing the traveling distance and travel time of the process solution from main connection bar 33 to the plurality of nozzle bars 31. Therefore, the problem that the etch rate varies between the center and edge portions of the substrate due to the temperature difference between the center and edge portions for a large size panel can be prevented.

A second temperature controller 50 for controlling the temperature of the process solution flowing through process solution supply pipe 30 is arranged adjacent to main connection bar 33. It is preferable that second temperature controller 50 includes a plurality of fluid supply pipes 51 and 52 arranged adjacent to main connection bar 33 through which the process solution flows. The plurality of fluid supply pipes 51 and 52 can also be arranged adjacent to assistant connection bars 32 and/or nozzle bars 31. In one example, the plurality of fluid supply pipes 51 and 52 contact main connection bar 33 and are preferably provided with hot or cold water or hot or cold air. In a further example, a hot coil can be used to heat main connection bar 33, and the air can be used to cool main connection bar 33.

A thermo-sensor 58 is arranged in process solution supply pipe 30 for feedback of the sensed temperature to modify the conditions of second temperature controller 50. That is, the temperature of the process solution is set to the designated temperature using PID techniques to control the cold or hot water or cold or hot air flowing through fluid supply pipes 51 and 52.

Referring again to both FIGS. 1 and 2, by controlling the temperature of the process solution flowing through main connection bar 33 using fluid supply pipes 51 and 52, the designated temperature as set by first temperature controller 40 is maintained in the process solution finally injected through the plurality of nozzles 80 within manufacturing device 100.

Since the temperature is controlled precisely and accurately to be the designated temperature, the margin of etching uniformity increases to prevent poor etching uniformity. Temperature deviation is the difference between measurements by thermometer 41 and thermo-sensor 58. Using conventional systems and methods, temperature deviation is between about 1.5 and 2 degrees Celsius when the designated temperature was set to 40 degrees. Advantageously, the present invention allows for a temperature deviation between about 0.3 and about 0.5 degrees in one example, with no intent to limit the invention thereby.

It is preferable that a pump 60 for pumping the process solution flowing through process solution supply pipe 30, and a filter 70 for removing solid contaminants, be arranged along process solution supply pipe 30 outside manufacturing device 100.

The process solution supply system and method according to the present invention is provided with the second temperature controller for controlling the temperature of the process solution flowing through the process solution supply pipe which enables the temperature of the process solution inside the process solution supply device and that injected onto the substrate through the process solution supply pipe to be substantially equal, which improves etching uniformity of a large size panel.

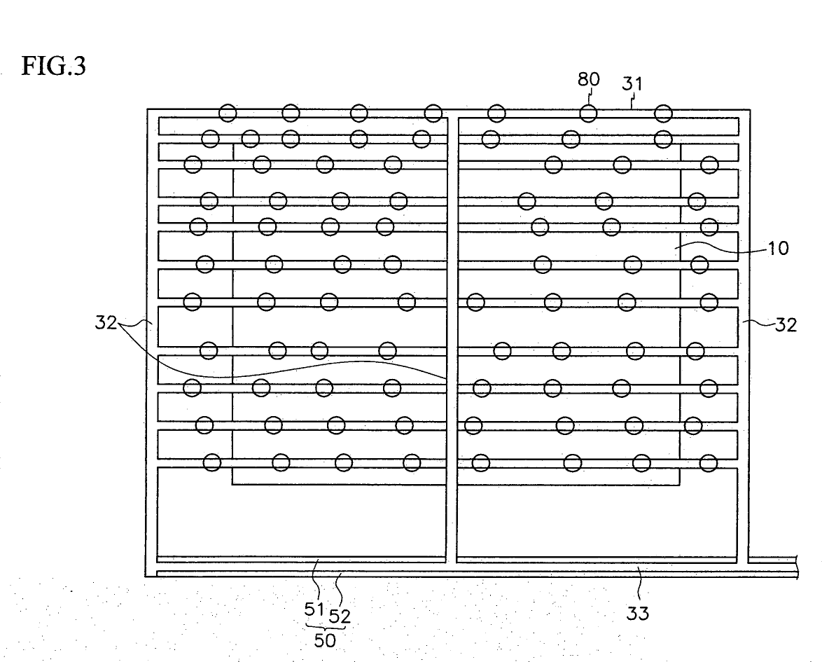

FIG. 3 is a layout view of a process solution supply system including three or more assistant connection bars 32 in accordance with another embodiment of the present invention. The process solution can flow from one connection bar 32 to the others or alternatively through all three connection bars 32 simultaneously. Advantageously, including three or more assistant connection bars 32 decreases the traveling distance and travel time of the process solution from main connection bar 33 to the plurality of nozzle bars 31 and thereby decreases heat loss. Therefore, the problem that the etch rate varies between the center and edge portions of the substrate due to the temperature difference between the center and edge portions for a large size panel can be further lowered.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A process solution supply system, comprising:
a process solution supply device for supplying a process solution at a first temperature, wherein the process solution supply device includes a first temperature control;
a processing unit including a plurality of nozzles for injecting the process solution onto a substrate; and
a pathway operably coupling the process solution supply device to the plurality of nozzles, wherein the pathway includes multiple paths and a second temperature control such that the process solution injected from the plurality of nozzles has a temperature substantially equal to the first temperature of the process solution from the process solution supply device.

2. The system of claim 1, wherein the process solution includes an etching solution.

3. The system of claim 1, wherein the first temperature control includes a heater in communication with a thermometer.

4. The system of claim 1, wherein the substrate includes a panel to be etched.

5. The system of claim 1, wherein the pathway includes a piping arrangement.

6. The system of claim 1, wherein the pathway includes a main supply pipe arranged in parallel to a plurality of nozzle pipes.

7. The system of claim 6, wherein the main supply pipe is operably coupled to a plurality of connection pipes that operably couple the plurality of nozzle pipes together.

8. The system of claim 7, wherein the main supply pipe is operably coupled to the process solution supply device, and further wherein the plurality of nozzle pipes include the plurality of nozzles.

9. The system of claim 1, wherein the second temperature control includes at least two pipes filled with fluid and operably contacting the pathway to control for temperature deviation.

10. The system of claim 9, wherein the second temperature control includes a thermo-sensor operably coupled to the pathway to provide information about the temperature of the process solution being injected from the plurality of nozzles.

11. The system of claim 1, further comprising a pump operably coupled to the pathway for pumping the process solution through the pathway.

12. The system of claim 1, further comprising a filter operably coupled to the pathway for filtering out contaminants from the process solution prior to being injected through the plurality of nozzles.

13. A process solution supply system, comprising:
a process solution supply device for supplying a process solution at a first temperature, wherein the process solution supply device includes a first temperature control;
a processing unit including a plurality of nozzles for injecting the process solution onto a substrate; and
a pathway operably coupling the process solution supply device to the plurality of nozzles, wherein the pathway includes a second temperature control and a main supply pipe arranged in parallel to a plurality of nozzle pipes, the main supply pipe being operably coupled to the plurality of nozzle pipes via a plurality of connecting pipes arranged perpendicular to the plurality of nozzle pipes, such that the process solution injected from the plurality of nozzles has a temperature substantially equal to the first temperature of the process solution from the process solution supply device.

14. The system of claim 13, wherein the main supply pipe is operably coupled to the process solution supply device, and further wherein the plurality of nozzle pipes include the plurality of nozzles.

15. The system of claim 13, wherein the second temperature control includes at least two pipes filled with fluid and operably contacting the pathway to control for temperature deviation.

16. A method for supplying process solution, comprising:
providing a process solution source that controls for temperature to supply process solution at a first temperature;
providing a plurality of nozzles for injecting the process solution from the process solution source onto a substrate; and
transporting the process solution from the process solution source to the plurality of nozzles via a pathway that controls for temperature such that the process solution injected from the plurality of nozzles has a temperature substantially equal to the first temperature of the process solution from the process solution supply source.

17. The method of claim 16, wherein the process solution source controls for temperature using a thermometer and a heater.

18. The method of claim 16, wherein the pathway includes a main supply pipe arranged in parallel to a plurality of nozzle pipes.

19. The system of claim 18, wherein the main supply pipe is operably coupled to a plurality of connection pipes that operably couple the plurality of nozzle pipes together.

20. The method of claim 16, wherein the pathway controls for temperature using a plurality of contacting pipes filled with a fluid.

21. The method of claim 16, wherein the pathway controls for temperature using a piping arrangement.

22. The method of claim 16, wherein the pathway controls for temperature using a thermo-sensor.
